(19) United States
(12) Patent Application Publication
(10) Pub. No.: US 2020/0051164 A1
(43) Pub. Date: Feb. 13, 2020

(54) Method, System, and Computer Program Product For Processing A Fund Disbursement Transaction

(71) Applicant: Visa International Service Association, San Francisco, CA (US)

(72) Inventor: Ankush Singhal, Dublin, CA (US)

(21) Appl. No.: 16/100,861

(22) Filed: Aug. 10, 2018

(51) Int. Cl. G06Q 40/02; G06Q 20/40; G06Q 20/26

(52) U.S. Cl. CPC G06Q 40/02; G06Q 20/26; G06Q 20/401

(57) ABSTRACT

A computer-implemented method for processing a fund disbursement transaction includes: receiving a fund disbursement request identifying a disbursement amount; determining the merchant account and the consumer account; generating a first authorization request based on the disbursement amount and the merchant account, the first authorization request configured to cause an acquirer system corresponding to the merchant account to determine whether the merchant account includes the disbursement amount; communicating the first authorization request; receiving a first authorization response; and generating a second authorization request configured to initiate a push payment of the disbursement amount to the consumer account.

### BACKGROUND OF THE INVENTION

### Field of the Invention

This invention relates to a method, system, and computer program product for processing fund disbursement transactions and, in one example, to a method, system, and computer program product to process fund disbursement transactions using an original credit transaction.

### Description of Related Art

Fund disbursement requests are commonly processed in order to disburse a disbursement amount from an enterprise merchant account to a consumer account. In one example, the enterprise merchant account is an account corresponding to an insurance company, and the consumer account is an account corresponding to a claimant who has purchased an insurance policy from the insurance company. Upon the consumer filing an insurance claim with the insurance company, the insurance company will disburse funds pursuant to the insurance policy to the consumer account in order to settle the claim. These disbursement requests must be timely processed.

Existing systems of processing such fund disbursement requests rely solely on acquirer controls established based partially on the creditworthiness of the enterprise merchant. The existing systems do not account for the actual amount of funds available in the enterprise merchant account. As a result, upon the fund disbursement request being within the requirements of the acquirer controls, the funds are disbursed by the acquirer to the consumer account, regardless of whether the enterprise merchant account contains sufficient funds to cover the transfer. Such systems place liability on the acquirer system, as opposed to the enterprise merchant, which is the entity having the fund deficiency. This acts as a barrier to the acquirer system utilizing the efficiencies of original credit transactions in fund disbursement transaction scenarios.

### SUMMARY OF THE INVENTION

Accordingly, and generally, provided is an improved method, system, and computer program product for processing fund disbursement transactions using original credit transaction transfers.

According to a non-limiting embodiment or aspect, provided is a computer-implemented method for processing a fund disbursement transaction including: receiving, with at least one processor of a disbursement provider system, a fund disbursement request identifying a disbursement amount to be disbursed to a consumer account from a merchant account; determining, with the at least one processor and based partially on the fund disbursement request, the merchant account from which the disbursement amount is to be transferred and the consumer account to which the disbursement amount is to be transferred; generating, with the at least one processor, a first authorization request based on the disbursement amount and the merchant account; communicating, with the at least one processor, the first authorization request to the acquirer system; receiving, with the at least one processor, a first authorization response from the acquirer system including a determination as to whether the merchant account includes the disbursement amount; and in response to determining, with the at least one processor, that the first authorization response includes an approval authorizing disbursal of the disbursement amount, generating a second authorization request configured to cause an issuer system corresponding to the consumer account to initiate a push payment of the disbursement amount to the consumer account.

In one non-limiting embodiment or aspect, the second authorization request may include a type identifier identifying an interchange fee associated with the fund disbursement transaction. The method may further include: in response to determining that the merchant account includes the disbursement amount, placing a hold on the merchant account for the disbursement amount. The second authorization request may be communicated within 1 hour of receiving the fund disbursement request. The disbursement provider system may include a payment gateway. The fund disbursement request may be initiated using a debit card corresponding to the consumer account. The acquirer system corresponding to the merchant account may be operated by an issuer that issued a debit card corresponding to the merchant account. The merchant account may correspond to an enterprise merchant.

According to a non-limiting embodiment or aspect, provided is a disbursement provider system for processing a fund disbursement transaction, including at least one server computer including at least one processor, the at least one server computer programmed and/or configured to: receive a fund disbursement request identifying a disbursement amount to be disbursed to a consumer account from a merchant account; determine, based partially on the fund disbursement request, the merchant account from which the disbursement amount is to be transferred and the consumer account to which the disbursement amount is to be transferred; generate a first authorization request based on the disbursement amount and the merchant account; communicate the first authorization request to the acquirer system; receive a first authorization response from the acquirer system including a determination as to whether the merchant account includes the disbursement amount; and in response to determining that the first authorization response includes an approval authorizing disbursal of the disbursement amount, generate a second authorization request configured to cause an issuer system corresponding to the consumer account to initiate a push payment of the disbursement amount to the consumer account.

In one non-limiting embodiment or aspect, the second authorization request may include a type identifier identifying an interchange fee associated with the fund disbursement transaction. The at least one server computer may be further programmed and/or configured to: in response to determining that the merchant account includes the disbursement amount, place a hold on the merchant account for the disbursement amount. The second authorization request may be communicated within 1 hour of receiving the fund disbursement request. The disbursement provider system may include a payment gateway. The fund disbursement request may be initiated using a debit card corresponding to the consumer account. The acquirer system corresponding to the merchant account may be operated by an issuer that issued a debit card corresponding to the merchant account. The merchant account may correspond to an enterprise merchant.

According to a non-limiting embodiment or aspect, provided is a computer program product for processing a fund disbursement transaction, including at least one non-transitory computer-readable medium including program instructions that, when executed by at least one processor, cause the at least one processor to: receive on a disbursement provider system a fund disbursement request identifying a disbursement amount to be disbursed to a consumer account from a merchant account; determine, based partially on the fund disbursement request, the merchant account from which the disbursement amount is to be transferred and the consumer account to which the disbursement amount is to be transferred; generate a first authorization request based on the disbursement amount and the merchant account; communicate the first authorization request to the acquirer system; receive a first authorization response from the acquirer system including a determination as to whether the merchant account includes the disbursement amount; and in response to determining that the first authorization response includes an approval authorizing disbursal of the disbursement amount, generate a second authorization request configured to cause an issuer system corresponding to the consumer account to initiate a push payment of the disbursement amount to the consumer account.

In one non-limiting embodiment or aspect, the second authorization request may include a type identifier identifying an interchange fee associated with the fund disbursement transaction. The program instructions may further cause the at least one processor to: in response to determining that the merchant account includes the disbursement amount, place a hold on the merchant account for the disbursement amount. The second authorization request may be communicated within 1 hour of receiving the fund disbursement request. The disbursement provider system may include a payment gateway. The fund disbursement request may be initiated using a debit card corresponding to the consumer account. The acquirer system corresponding to the merchant account may be operated by an issuer that issued a debit card corresponding to the merchant account. The merchant account may correspond to an enterprise merchant.

Further embodiments or aspects are set forth in the following numbered clauses:

Clause 1: A computer-implemented method for processing a fund disbursement transaction, comprising: receiving, with at least one processor of a disbursement provider system, a fund disbursement request identifying a disbursement amount to be disbursed to a consumer account from a merchant account; determining, with the at least one processor and based partially on the fund disbursement request, the merchant account from which the disbursement amount is to be transferred and the consumer account to which the disbursement amount is to be transferred; generating, with the at least one processor, a first authorization request based on the disbursement amount and the merchant account; communicating, with the at least one processor, the first authorization request to the acquirer system; receiving, with the at least one processor, a first authorization response from the acquirer system including a determination as to whether the merchant account includes the disbursement amount; and in response to determining, with the at least one processor, that the first authorization response comprises an approval authorizing disbursal of the disbursement amount, generating a second authorization request configured to cause an issuer system corresponding to the consumer account to initiate a push payment of the disbursement amount to the consumer account.

Clause 2: The computer-implemented method of clause 1, wherein the second authorization request comprises a type identifier identifying an interchange fee associated with the fund disbursement transaction.

Clause 3: The computer-implemented method of clause 1 or 2, further comprising: in response to determining that the merchant account includes the disbursement amount, placing a hold on the merchant account for the disbursement amount.

Clause 4: The computer-implemented method of any of clauses 1-3, wherein the second authorization request is communicated within 1 hour of receiving the fund disbursement request.

Clause 5: The computer-implemented method of any of clauses 1-4, wherein the disbursement provider system comprises a payment gateway.

Clause 6: The computer-implemented method of any of clauses 1-5, wherein the fund disbursement request is initiated using a debit card corresponding to the consumer account.

Clause 7: The computer-implemented method of any of clauses 1-6, wherein the acquirer system corresponding to the merchant account is operated by an issuer that issued a debit card corresponding to the merchant account.

Clause 8: The computer-implemented method of any of clauses 1-7, wherein the merchant account corresponds to an enterprise merchant.

Clause 9: A disbursement provider system for processing a fund disbursement transaction, comprising at least one server computer including at least one processor, the at least one server computer programmed and/or configured to: receive a fund disbursement request identifying a disbursement amount to be disbursed to a consumer account from a merchant account; determine, based partially on the fund disbursement request, the merchant account from which the disbursement amount is to be transferred and the consumer account to which the disbursement amount is to be transferred; generate a first authorization request based on the disbursement amount and the merchant account; communicate the first authorization request to the acquirer system; receive a first authorization response from the acquirer system including a determination as to whether the merchant account includes the disbursement amount; and in response to determining that the first authorization response comprises an approval authorizing disbursal of the disbursement amount, generate a second authorization request configured to cause an issuer system corresponding to the consumer account to initiate a push payment of the disbursement amount to the consumer account.

Clause 10: The system of clause 9, wherein the second authorization request comprises a type identifier identifying an interchange fee associated with the fund disbursement transaction.

Clause 11: The system of clause 9 or 10, wherein the at least one server computer is further programmed and/or configured to: in response to determining that the merchant account includes the disbursement amount, place a hold on the merchant account for the disbursement amount.

Clause 12: The system of any of clauses 9-11, wherein the second authorization request is communicated within 1 hour of receiving the fund disbursement request.

Clause 13: The system of any of clauses 9-12, wherein the disbursement provider system comprises a payment gateway.

Clause 14: The system of any of clauses 9-13, wherein the fund disbursement request is initiated using a debit card corresponding to the consumer account.

Clause 15: The system of any of clauses 9-14, wherein the acquirer system corresponding to the merchant account is operated by an issuer that issued a debit card corresponding to the merchant account.

Clause 16: The system of any of clauses 9-15, wherein the merchant account corresponds to an enterprise merchant.

Clause 17: A computer program product for processing a fund disbursement transaction, comprising at least one non-transitory computer-readable medium including program instructions that, when executed by at least one processor, cause the at least one processor to: receive on a disbursement provider system a fund disbursement request identifying a disbursement amount to be disbursed to a consumer account from a merchant account; determine, based partially on the fund disbursement request, the merchant account from which the disbursement amount is to be transferred and the consumer account to which the disbursement amount is to be transferred; generate a first authorization request based on the disbursement amount and the merchant account; communicate the first authorization request to the acquirer system; receive a first authorization response from the acquirer system including a determination as to whether the merchant account includes the disbursement amount; and in response to determining that the first authorization response comprises an approval authorizing disbursal of the disbursement amount, generate a second authorization request configured to cause an issuer system corresponding to the consumer account to initiate a push payment of the disbursement amount to the consumer account.

Clause 18: The computer program product of clause 17, wherein the second authorization request comprises a type identifier identifying an interchange fee associated with the fund disbursement transaction.

Clause 19: The computer program product of clause 17 or 18, wherein the program instructions further cause the at least one processor to: in response to determining that the merchant account includes the disbursement amount, place a hold on the merchant account for the disbursement amount.

Clause 20: The computer program product of any of clauses 17-19, wherein the second authorization request is communicated within 1 hour of receiving the fund disbursement request.

Clause 21: The computer program product of any of clauses 17-20, wherein the disbursement provider system comprises a payment gateway.

Clause 22: The computer program product of any of clauses 17-21, wherein the fund disbursement request is initiated using a debit card corresponding to the consumer account.

Clause 23: The computer program product of any of clauses 17-22, wherein the acquirer system corresponding to the merchant account is operated by an issuer that issued a debit card corresponding to the merchant account.

Clause 24: The computer program product of any of clauses 17-23, wherein the merchant account corresponds to an enterprise merchant.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1A is a schematic view of an existing system for processing a fund disbursement transaction;

FIG. 1B is a step diagram of an existing method for processing a fund disbursement transaction;

FIG. 2A is a schematic view of a non-limiting embodiment or aspect of a system for processing a fund disbursement transaction according to principles of the present invention;

FIG. 2B is a step diagram of a non-limiting embodiment or aspect of a method for processing a fund disbursement transaction according to principles of the present invention;

FIG. 3 is a step diagram of another non-limiting embodiment or aspect of a method for processing a fund disbursement transaction according to principles of the present invention;

FIG. 4 is a schematic view of a non-limiting embodiment or aspect of a split authorization system for processing a fund disbursement transaction according to principles of the present invention;

FIG. 5 is a step diagram of another non-limiting embodiment or aspect of a method for processing a fund disbursement transaction according to principles of the present invention; and

FIG. 6 is a process flow diagram of a non-limiting embodiment or aspect of a method for processing a fund disbursement transaction according to principles of the present invention.

### DESCRIPTION OF THE INVENTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

As used herein, the terms “communication” and “communicate” may refer to the reception, receipt, transmission, transfer, provision, and/or the like, of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet, and/or the like) that includes data. It will be appreciated that numerous other arrangements are possible.

As used herein, the term “transaction service provider” may refer to an entity that receives transaction authorization requests (including requests for processing fund disbursement transactions) from merchants, acquirers, payment gateways, or other entities and provides guarantees of payment, in some cases through an agreement between the transaction service provider and an issuer institution. For example, a transaction service provider may include a payment network such as Visa® or any other entity that processes transactions. The term “transaction processing server” may refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

As used herein, the term “issuer institution” or “issuer” may refer to one or more entities, such as a bank, that provide accounts to customers for conducting transactions (e.g., fund disbursement transactions and payment transactions), such as using a credit or debit card. For example, an issuer institution may provide an account identifier, such as a personal account number (PAN), to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer systems operated by or on behalf of an issuer institution, such as a server computer executing one or more software applications. For example, an issuer system may include one or more authorization servers for authorizing a transaction.

As used herein, the term “acquirer institution” or “acquirer” may refer to an entity licensed and/or approved by the transaction service provider to originate transactions (e.g., payment transactions) using a portable financial device associated with the transaction service provider. The transactions the acquirer institution may originate may include fund disbursement transactions (e.g., using original credit transactions (OCTs), account funding transactions (AFTs), and/or the like). In some non-limiting embodiments, an acquirer institution may be a financial institution, such as a bank. The acquirer institution may provide accounts to merchants for conducting transactions, including fund disbursement transactions. As used herein, the term “acquirer system” may refer to one or more computer systems, computer devices, software applications, and/or the like operated by or on behalf of an acquirer institution.

As used herein, the term “fund disbursement transaction” may refer to a transaction in which funds are transferred from a payer account to a recipient account. Examples of such transactions include disbursements payed out from an insurance company or health plan (payer) to a claimant (recipient).

As used herein, the term “original credit transaction” (OCT) may refer to a transaction method in which funds are credited (pushed) to a recipient's account. An OCT transaction may also be referred to as a “push payment”. Push payments are initiated with an individual or entity sending (“pushing”) funds to a recipient, rather than the recipient requesting (“pulling”) payment. As used herein, the term “account funding transaction” (AFT) may refer to a transaction method in which funds are debited (“pulled”) from a senders account.

As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “enterprise merchant” may refer to a merchant that utilizes fund disbursement transactions to transfer funds to an individual (e.g., a customer, employee, or contractor of the enterprise merchant) or other entity. Non-limiting examples of enterprise merchants include companies based around the sharing economy (e.g., a ridesharing company disbursing payouts to its drivers); insurance companies and/or health plans (e.g., disbursing funds to its claimants); government agencies (e.g., disbursing payment to its business contractors); and the like.

As used herein, the term “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments, the portable financial device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, fund disbursement transaction processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, the term “disbursement provider” may refer to an entity that provides merchants, such as an enterprise merchant, services enabling the merchants to disburse funds to recipients, such as consumers thereof or other merchants. The disbursement provider may be the payment gateway. As used herein, the term “disbursement provider system” may refer to one or more computer systems, computer devices, servers, groups of servers, and/or the like, operated by or on behalf of the disbursement provider.

As used herein, the term “server” may refer to or include one or more processors or computers, storage devices, or similar computer arrangements that are operated by or facilitate communication and processing for multiple parties in a network environment, such as the internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments or aspects of the present invention are directed to a method, system, and computer program product for processing a fund disbursement transaction. Unlike existing systems, the non-limiting embodiments provide a unique arrangement of components that involves the acquirer system before funds are disbursed. The system may utilize a new split authorization method, the first authorization request being a communication to the acquirer system (which functions as an issuer system of the merchant account) to ensure that sufficient funds are available in the merchant account before the disbursement is initiated. In this way, non-limiting embodiments advantageously base a determination that funds should be disbursed from the merchant account to the consumer account based on funds actually present in the merchant account, instead of based merely on acquirer controls or on creditworthiness of the merchant and not accounting for actual funds contained in the merchant account. The system may initiate the second authorization request only if the first authorization request returns a response indicating that sufficient funds are available in the merchant account. This arrangement ensures that only fund disbursements that the merchant has sufficient funds to cover are actually made. Non-limiting embodiments provide all the above-described advantages, while still making funds of the disbursement available to the consumer within 1 hour, such as within 30 minutes, if the merchant account has sufficient funds to complete the disbursement. The non-limiting embodiments provide an improved system for processing a fund disbursement request because funds are timely disbursed to the consumer while first ensuring through communication with the acquirer system that the merchant account can sufficiently cover the funds to be disbursed.

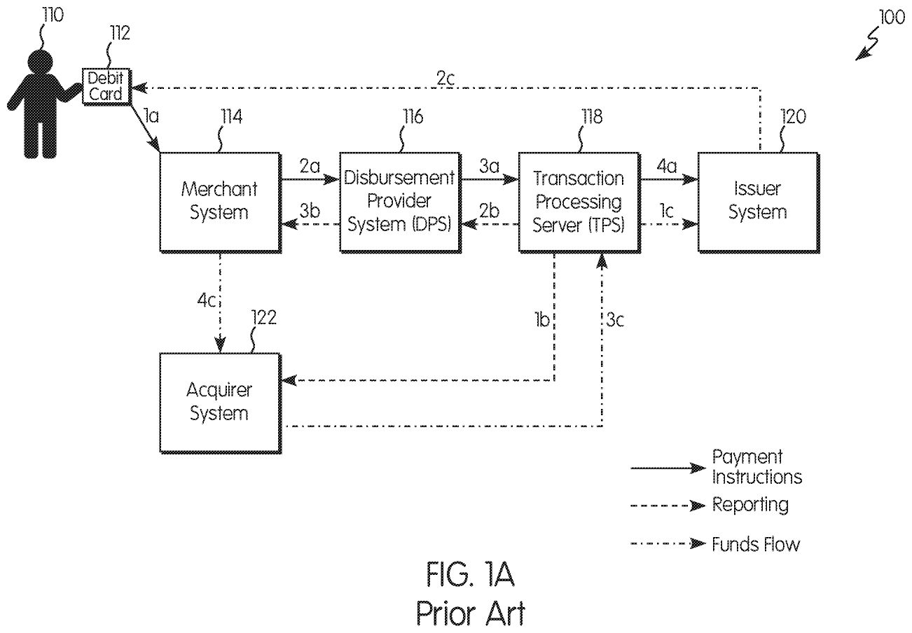

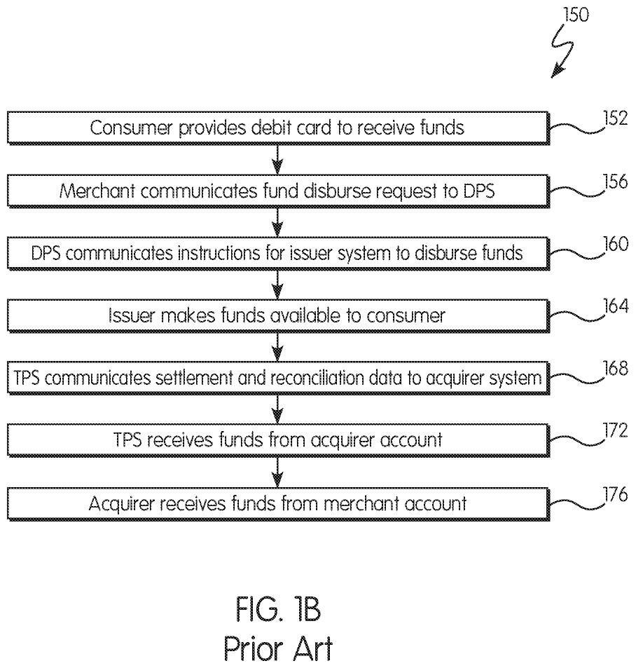

Referring to FIG. 1, an existing system 100 for processing a fund disbursement transaction is shown. The system 100 may include a consumer 110 who has a consumer account and a debit card 112 associated with the consumer account. The debit card may include an account identifier, such as a 16-digit personal account number (PAN). The consumer account may be configured to receive funds (be a recipient account) from a fund disbursement transaction or to disburse funds (be a source account) to a different recipient account from a fund disbursement transaction. The debit card may be used to initiate the fund disbursement transaction and/or to identify the consumer account as the source account or recipient account of the fund disbursement transaction. The debit card 112 may be used to initiate the fund disbursement transaction using a point-of-sale device or by the consumer providing the account identifier (or other information associated with the account) to an entity involved with disbursing the funds from the source account to the recipient account.

The system 100 may also include a merchant system 114 operated by or on behalf of a merchant, such as an enterprise merchant. In one example, the merchant may be an individual or entity that disburses funds to its consumers, employees, contractors, or the like via a fund disbursement transaction. The merchant may be an insurance provider, a healthcare provider, or other entity that pays out lump sums to its claimants (its customers) during processing of a claim. A merchant account containing funds of the merchant may be associated with the merchant system 114 and the merchant. The merchant account may be configured to receive funds (be a recipient account) from a fund disbursement transaction or to disburse funds (be a source account) to a different recipient account from a fund disbursement transaction. The merchant account may include a debit card associated therewith, which may be used to initiate the fund disbursement transaction and/or to identify the merchant account as the source account of the fund disbursement transaction. The merchant debit card may include an account identifier, such as a 16-digit PAN.

The system 100 may also include a disbursement provider system (DPS) 116. The DPS 116 may be configured to receive and process fund disbursement requests from the merchant system 114. The DPS 116 may be a payment gateway, a transaction service provider, or any other intermediary entity involved in processing fund disbursement transactions.

The system 100 may also include a transaction processing server 118 operated by or on behalf of a transaction service provider. The transaction processing server (TPS) 118 may be configured to process various transactions, such as payment transactions initiated using a portable financial device and fund disbursement transactions as described herein. The TPS 118 may also process interchange fees associated with processing the type of transaction being processed by the TPS 118.

The system 100 may also include an issuer system 120 operated by or on behalf of an issuer, which may be a bank or other financial institution. The issuer may be the issuer of the consumer account and the issuer of the consumer debit card 112.

The system 100 may also include an acquirer system 122 operated by or on behalf of an acquirer, such as a merchant bank. The acquirer may be the acquirer of the merchant associated with the merchant system 114. The acquirer may also function as the issuer of the merchant (though the acquirer will be referred to herein as the acquirer so as not to be confused with the previously-described issuer system 120 of the consumer), as the acquirer may be the issuer of the merchant debit card and the merchant account.

With continued reference to FIG. 1A, the flow of payment instructions of the existing system 100 are indicated by the solid arrows. In this flow of payment instructions, at a step 1a, the consumer 110 may present or communicate account information (e.g., the account identifier) associated with the consumer debit card 112 to the merchant system 114. In response, at a step 2a, the merchant system 114 may communicate a fund disbursement request to the DPS. The fund disbursement request may identify a disbursement amount to be disbursed to the consumer account from the merchant account. The fund disbursement request may further include account identifiers associated with the consumer debit card 112 and/or the merchant debit card. Other relevant information may be included in the fund disbursement request as required to process the fund disbursement request. At a step 3a, the DPS generates a single authorization request configured to cause the issuer system 120 to initiate a push payment of the disbursement amount to the consumer account. The TPS 118 may receive the single authorization request from the DPS 116 and communicate the single authorization request to the issuer system 120 at a step 4a. It will be appreciated that the DPS 116, TPS 118, and/or the issuer system 120 may be separate systems and/or entities (as shown in the flow of FIG. 1) or any of these several entities/systems may be combined into a single entity/system. In one non-limiting example, the DPS 116, TPS 118, and issuer system 120 are a single system operated by or on behalf of a single entity that performs each of the above-described steps associated with each of the individual entities. It will be appreciated throughout this disclosure that the DPS 116, TPS 118, and/or issuer system 120 may be a single system or split out into several separate systems.

It will be appreciated that the above-described process flow or any process flow described hereinafter that the ordered steps described herein are non-limiting, and different orders of steps in the flow are contemplated unless expressly specified to the contrary.

With continued reference to FIG. 1A, the flow of reporting messages of the existing system 100 are indicated by the dashed arrows. At a step 1b, the TPS 118 may deliver settlement and reconciliation data for reporting to the acquirer system 122. This information may be used to settle the funds transferred during the fund disbursement transaction. At a step 2b, the TPS 118 may communicate a report message to the DPS 116 that the fund disbursement request has been processed and the issuer system 120 has or will make the funds available to the consumer account. At a step 3b, the DPS 116 may communicate this report message to the merchant system 116. These report messages may be communicated in any order.

With continued reference to FIG. 1A, the flow of funds in the existing system 100 are indicated by the dashed-dot arrows. At a step 1c, the TPS 118 may make funds available to the issuer system 120 for the disbursement amount. This may be performed by the TPS 118 pushing the funds to the issuer system 120 or by the issuer system 120 pulling the funds from the TPS 118. At a step 2c, the issuer system 120 may push the funds for the disbursement amount to the consumer account. It will be appreciated that in some embodiments, step 1c and 2c may be switched in order. At a step 3c, the acquirer system 122 makes funds for the disbursement amount available to the TPS 118. This may be performed by the TPS 118 pulling the funds from the acquirer system 122 or by the acquirer system 122 pushing the funds to the TPS 118. At a step 4c, the merchant system 114 makes funds for the disbursement amount available to the acquirer system 122. This may be performed by the acquirer system 122 pulling the funds from the merchant system 114 or by the merchant system 114 pushing the funds to the acquirer system 122.

Referring to FIG. 1B, an existing method 150 for processing a fund disbursement transaction is shown. In the method 150, at a first step 152, the consumer 110 provides the consumer debit card 112 (or information thereof) to the merchant system 114 to initiate the fund disbursement transaction, such that the disbursement amount can be disbursed to the consumer account. At a second step 156, the merchant system 114 communicates the fund disbursement request to the DPS 116 as previously described.

At a third step 160, the DPS 116 communicates instructions in the form of a single authorization request, which causes the issuer system 120 to initiate a push payment of the disbursement amount to the consumer account. In some non-limiting embodiments, the single authorization request may be generated and communicated in accordance with pre-determined acquirer-established rules. These acquirer-established rules do not include determining whether sufficient funds are available in the merchant account to cover the disbursement amount. Instead, the acquirer-established rules may include transaction limits and hourly/daily/weekly/monthly/quarterly thresholds for a particular merchant. For example, the acquirer-established rules may include any of the following: maximum amount for a single fund disbursement transaction, maximum amount of fund disbursement transactions for a time period (e.g., a day), and/or maximum count of fund disbursement requests for a time period. The acquirer-established rules may be based on creditworthiness of the merchant. The acquirer-established rules are predetermined rules such that they are communicated to the DPS 116 and/or the TPS, and or the issuer system 120, such that the acquirer system 122 is not communicated with prior to disbursement of funds to determine whether the fund disbursement request is within the acquirer-established rules. Instead, the DPS 116 may determine whether the fund disbursement request follows the acquirer-established rules and generate the single authorization request if so. In another example, the DPS 116 may generate the single authorization request and communicate the single authorization request to the TPS 118 or issuer system 120, which considers whether the fund disbursement request follows the acquirer-established rules before allowing further processing of the fund disbursement request (including the disbursement of funds). In any case, the existing systems that do include acquirer-established rules fail to consider the amount of funds actually in the merchant account prior to processing or disbursing the funds of the fund disbursement request.

At a fourth step 164, the issuer system 120 may make the disbursement amount available to the consumer account, such as via an OCT transaction (push payment) to the consumer account for the disbursement amount. At a fifth step 168, the TPS 118 may communicate the settlement and reconciliation data to the acquirer system 122 as previously described. At a sixth step 172, the TPS 118 may receive funds for the disbursement amount from an acquirer account from the acquirer system 122. At a seventh step 176, the acquirer system 122 may receive funds for the disbursement amount from the merchant account from the merchant system 114.

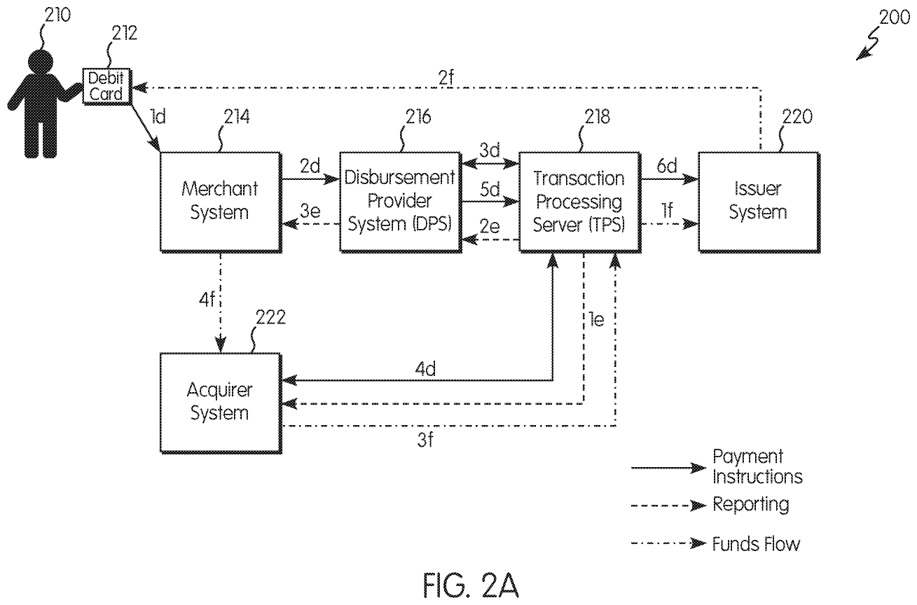

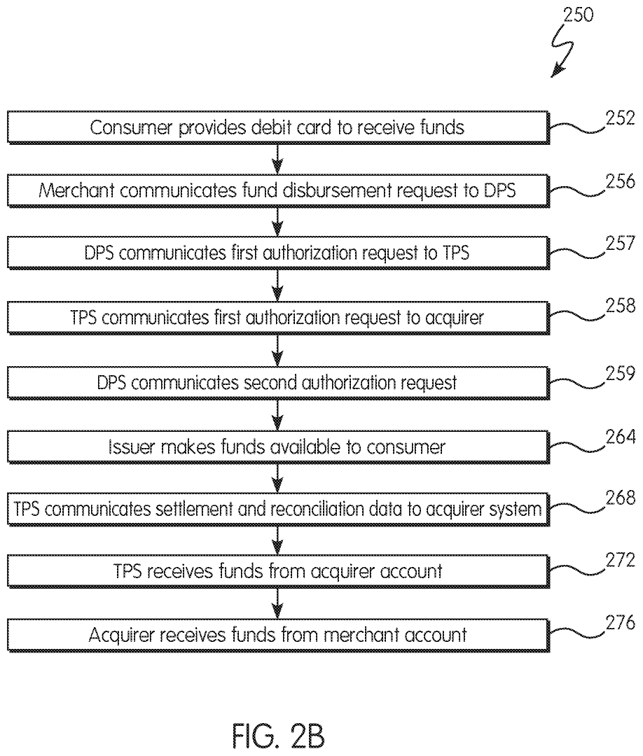

Referring to FIG. 2A, a non-limiting system 200 for processing a fund disbursement transaction according to some non-limiting embodiments is shown. The system 200 may include the consumer 210, the consumer debit card 212, the merchant system 214, the DPS 216, the TPS 218, the issuer system 220, and/or the acquirer system 222, which include the features of their corresponding counterpart from the system 100 of FIG. 1. However, differences of the inventive system 200 compared to the existing system 100 and the features of its components are hereinafter described.

With continued reference to FIG. 2A, the flow of payment instructions of the system 200 are indicated by the solid arrows. In this flow of payment instructions, at a step 1d, the consumer 210 may present or communicate account information (e.g., the account identifier) associated with the consumer debit card 212 to the merchant system 214 to initiate the fund disbursement transaction. In response, at a step 2d, the merchant system 214 may communicate a fund disbursement request (as previously described) to the DPS 216. At a step 3d, the DPS 216 may determine the merchant account and/or the consumer account from the fund disbursement request and generate a first authorization request based partially on the disbursement amount and the merchant account. The first authorization request is configured to cause the acquirer system 222 corresponding to the merchant account to determine whether the merchant account includes the disbursement amount and communicate a first authorization response. The first authorization response may indicate the amount of available funds in the account or may return a binary response as to whether the inquired upon transaction amount can be covered by the available funds in the account. In some non-limiting examples, the first authorization response is configured to initiate an account funds transfer (AFT) or other authorization request to verify that sufficient funds are available in the merchant account. The DPS 216 may generate and communicate the first authorization request to the TPS 218. At a step 4d, the TPS 218 may communicate the first authorization request to the acquirer system 222 of the merchant account. The TPS 218 and/or the DPS may receive a first authorization response from the acquirer system 222, which may indicate whether the merchant account contains sufficient funds to cover the disbursement amount (an approval authorizing disbursal or a decline denying disbursal). Thus, in response to receiving the first authorization request, the acquirer system 222 may determine whether the merchant account presently has sufficient funds that equal or exceed the disbursement amount. In response to determining that the first authorization response includes an approval authorizing disbursal of the disbursement amount (from the acquirer system 222), the DPS 216 may generate a second authorization request configured to initiate a push payment of the disbursement amount to the consumer account. The second authorization request may be generated and communicated to the TPS 218 at a step 5d. The TPS 218 may communicate the second authorization request to the issuer system 220 at a step 6d.

With continued reference to FIG. 2A, the flow of reporting messages of the system 200 are indicated by the dashed arrows. At a step 1e, the TPS 218 may deliver settlement and reconciliation data for reporting to the acquirer system 222. This information may be used to settle the funds transferred during the fund disbursement transaction. At a step 2e, the TPS 218 may communicate a report message to the DPS 216 that the fund disbursement request has been processed and the issuer system 220 has or will make the funds available to the consumer account. At a step 3e, the DPS 216 may communicate this report message to the merchant system 216. These report messages may be communicated in any order.

With continued reference to FIG. 2A, the flow of funds flow in the system 200 are indicated by the dashed-dot arrows. At a step 1f, the TPS 218 may make funds available to the issuer system 220 pursuant to the second authorization request for the disbursement amount. This may be performed by the TPS 218 pushing the funds to the issuer system 220 or by the issuer system 220 pulling the funds from the TPS 218. At a step 2f, the issuer system 220 may push the funds for the disbursement amount to the consumer account. It will be appreciated that in some embodiments, step 1f and 2f may be switched in order. At a step 3f, the acquirer system 222 makes funds for the disbursement amount available to the TPS 218. This may be performed by the TPS 218 pulling the funds from the acquirer system 222 or by the acquirer system 222 pushing the funds to the TPS 218. At a step 4f, the merchant system 214 makes funds for the disbursement amount available to the acquirer system 222. This may be performed by the acquirer system 222 (or the TPS 218 on behalf of the acquirer system 222) pulling the funds from the merchant system 214 or by the merchant system 214 (or the TPS 218 on behalf of the merchant system 214) pushing the funds to the acquirer system 222.

Referring to FIG. 2B, a non-limiting method 250 for processing a fund disbursement transaction according to some non-limiting embodiments is shown. In the method 250, at a first step 252, the consumer 210 provides the consumer debit card 212 to the merchant system 214 to initiate the fund disbursement transaction, such that the disbursement amount can be disbursed to the consumer account. At a second step 256, the merchant system 214 communicates the fund disbursement request to the DPS 216 as previously described.

With continued reference to FIG. 2B, at a third step 257, the DPS 216 may generate and communicate the first authorization request to the TPS 218. At a fourth step 258, the TPS 218 may communicate the first authorization request to the acquirer system 222. In response to receiving the first authorization request, the acquirer system 222 may determine whether the merchant account presently has sufficient funds to cover the disbursement amount. In this way, the acquirer system 222 ensures that the merchant account has at least the disbursement amount in the merchant account at the time of the fund disbursement transaction being processed. Upon determining that sufficient funds are available in the merchant account, a hold may be placed on the merchant account for the disbursement amount, such that funds in the merchant account do not dip below the required funds to cover the disbursement amount before the fund disbursement transaction is processed to completion.

In the present method 250, the DPS 216, the TPS 218, and/or the issuer system 220, and/or the acquirer system 222 may additionally consider the previously-described acquirer-established rules to further determine whether the fund disbursement transaction should be processed to completion. However, the acquirer-established rules do not eliminate the step of the acquirer system 222 determining whether the merchant account has sufficient funds to cover the disbursement amount.

The acquirer system 222 may communicate a first authorization response to the TPS 218 and/or the DPS 216 that includes whether sufficient funds are available in the merchant account to cover the disbursement amount.

At a fifth step 259, in response to receiving a first authorization response from the acquirer system 222 that the first authorization response includes an approval authorizing disbursal (that the merchant account has sufficient funds to cover the disbursement amount), the DPS 216 may generate a second authorization request. The second authorization request may be configured to cause the issuer system 220 to initiate a push payment of the disbursement amount to the consumer account. The second authorization request may be communicated to the TPS 218 and/or the issuer system 220. The second authorization request may be communicated by the DPS 216 within 1 hour of the DPS receiving the disbursement request, such as within 30 minutes, within 20 minutes, within 15 minutes, within 10 minutes, with 5 minutes, or substantially in real time (less than 1 minute as used herein).

In some non-limiting embodiments or aspects, the second authorization request may further include a type identifier, which identifies the type of transaction being processed. The second authorization request may include a type identifier that identifies the transaction being processed as a fund disbursement transaction in accordance with some non-limiting embodiments. During processing, systems of the entities charging an interchange fee for processing of the fund disbursement transaction may receive their interchange fee based on the type identifier and the rate associated with the type identifier. The interchange fee associated with processing a fund disbursement transaction may be the same or different (higher or lower) than other types of processed transactions. The interchange fee may be automatically charged by the relevant system (e.g., the TPS) based on the type identifier.

With continued reference to FIG. 2B, at a sixth step 264, the issuer system 220 may make the disbursement amount available to the consumer account, such as via an OCT transaction (push payment) to the consumer account for the disbursement amount. The funds may be made available in the consumer account by the issuer system within 1 hour of the DPS receiving the disbursement request, such as within 30 minutes, within 20 minutes, within 15 minutes, within 10 minutes, with 5 minutes, or substantially in real time. At a seventh step 268, the TPS 218 may communicate the settlement and reconciliation data to the acquirer system 222 as previously described. At an eighth step 272, the TPS 218 may receive funds for the disbursement amount from an acquirer account from the acquirer system 222. At a ninth step 276, the acquirer system 222 may receive funds for the disbursement amount from the merchant account from the merchant system 214.

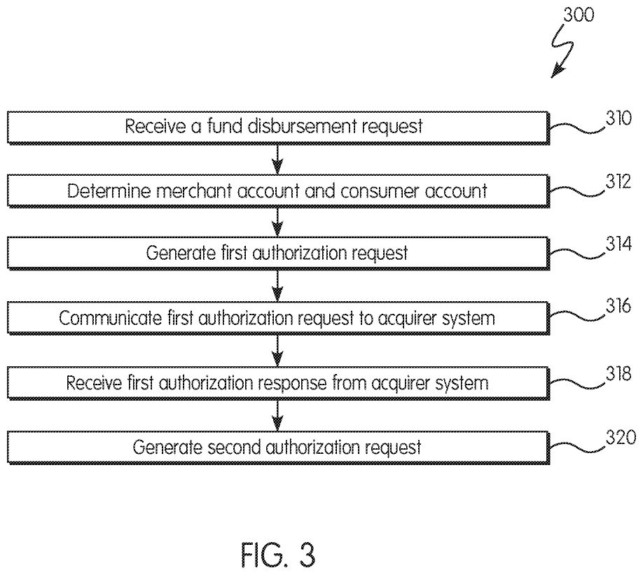

Referring to FIG. 3, a method 300 for processing a fund disbursement transaction is shown. At a first step 310, the DPS may receive the fund disbursement request identifying a disbursement amount to be disbursed to a consumer account from a merchant account. At a step 312, the DPS may determine, based partially on the fund disbursement request, the merchant account from which the disbursement amount is to be transferred and the consumer account to which the disbursement amount is to be transferred. At a step 314, the DPS may generate a first authorization request based on the disbursement amount and the merchant account, and the first authorization request may be configured to cause an acquirer system corresponding to the merchant account to determine whether the merchant account includes the disbursement amount. At a step 316, the DPS may communicate the first authorization request to the acquirer system. At a step 318, the DPS may receive a first authorization response from the acquirer system. At a step 320, the DPS may, in response to determining that the first authorization response includes an approval authorizing disbursal of the disbursement amount, generate a second authorization request configured to cause an issuer system corresponding to the consumer account to initiate a push payment of the disbursement amount to the consumer account.

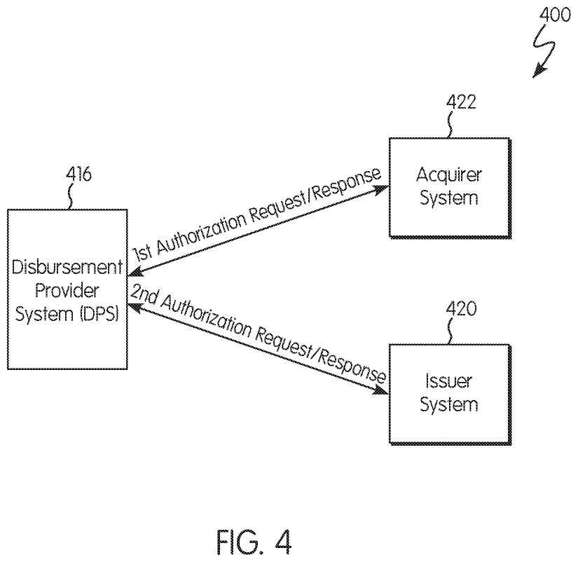

Referring to FIG. 4, a non-limiting embodiment or aspect of a split authorization system 400 for processing a fund disbursement transaction is shown. In this system, upon receiving the fund disbursement request from the merchant system (not shown), the DPS 416 splits processing of the fund disbursement transaction into two authorization requests. The DPS 416 first communicates the first authorization request (previously described) to the acquirer system 422. The DPS 416 may communicate the first authorization request directly to the acquirer system 422, or the DPS 416 may indirectly communicate the first authorization request to the acquirer system 422, such as through the TPS (not shown). Upon determining that the first authorization response (previously described) from the acquirer system 422 includes an approval authorizing disbursal of the disbursement amount, the DPS then communicates the second authorization response (previously described) to the issuer system 420. The DPS 416 may communicate the second authorization request directly to the issuer system 420, or the DPS 416 may indirectly communicate the second authorization request to the issuer system 420, such as through the TPS (not shown).

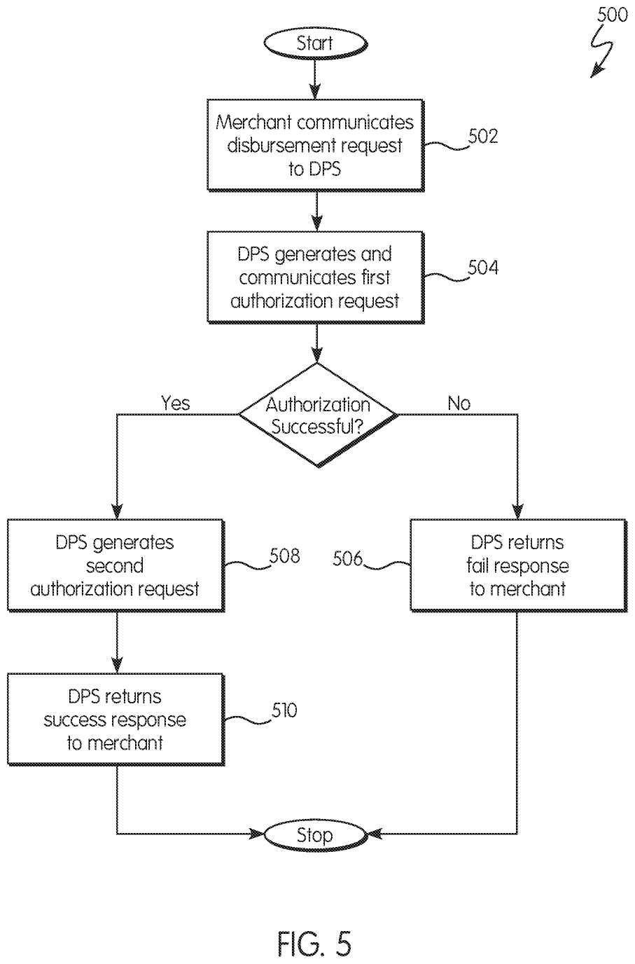

Referring to FIG. 5, a non-limiting embodiment or aspect of a method 500 for processing a fund disbursement transaction is shown. At step 502, the merchant system communicates a fund disbursement request to the DPS. At step 504, the DPS generates and communicates the first authorization request to the acquirer system (directly or through an intermediary system). The DPS receives the first authorization response from the acquirer system (directly or through an intermediary system). Upon the DPS determining that the first authorization response includes a decline of the fund disbursement transaction (authorization unsuccessful), the DPS communicates with the merchant system to notify the merchant system of the failed processing of the fund disbursement request (at step 506). This notification may include a reasons for the fund disbursement request being declined, such as insufficient funds or failure to meet one of the acquirer-established rules. Upon the DPS determining that the first authorization response includes an approval of the fund disbursement transaction (authorization successful), the DPS generates and communicates the second authorization request (at step 508). At step 510, the DPS further communicates with the merchant system to notify the merchant system of the successful processing of the fund disbursement request.

In a further, non-limiting embodiment or aspect, a computer program product for processing a fund disbursement transaction includes at least one non-transitory computer readable medium including program instructions that, when executed by at least one processor, cause the at least one processor to execute one of the inventive systems or methods (e.g., system 200, system 400, method 250, method 300, method 500, method 600) described herein. The at least one processor may include the DPS.

The following example is provided to illustrate an embodiment of the system, method, and computer program product for processing a fund disbursement transaction, and is not meant to be limiting.

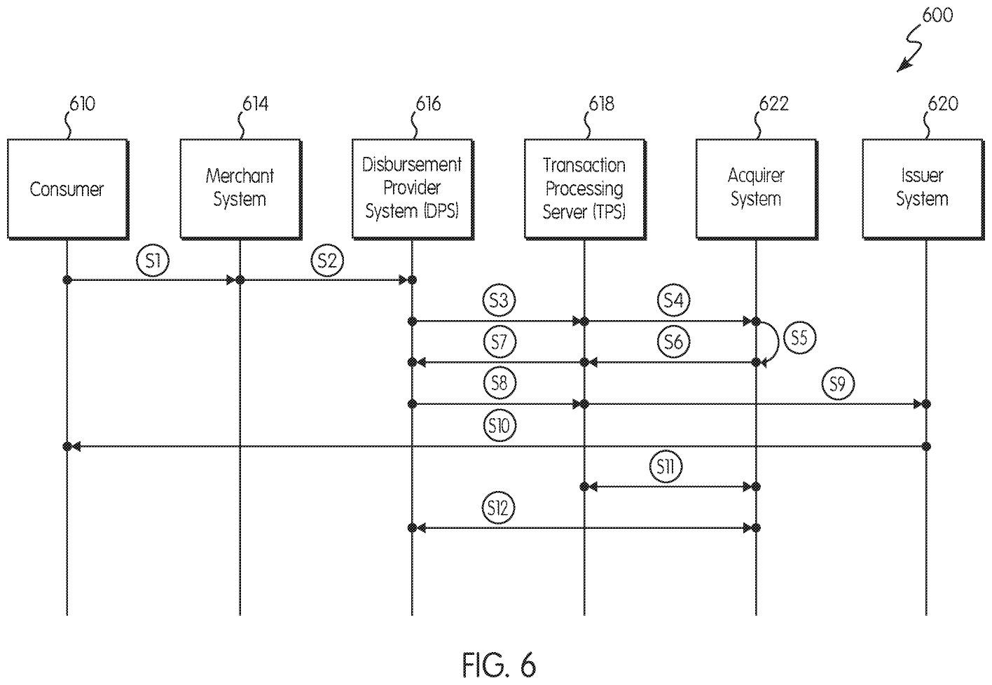

Referring to FIG. 6, one non-limiting example of a method for processing a fund disbursement transaction is shown. In this example, Paul Jones is a consumer 610, and an individual who owns a homeowner's insurance policy with Acme Insurance (an enterprise merchant). Acme Insurance operates a merchant system 614 as previously described. Paul Jones has a debit card and consumer account, which were issued to him by First Bank (an issuer), which operates an issuer system 620 as previously described. Acme Insurance has a debit card and a merchant account, which were issued to it by First Acquirer (an acquirer of Acme Insurance). First Acquirer operates an acquirer system 622 as previously described. The Acme Insurance debit card is associated with a First Transaction Service Provider (“First TSP”), which operates a TPS 618 as previously described. First Gateway functions as a payment gateway to Acme Insurance, and First Gateway operates a DPS 616 as previously described.

Last month, a thunder storm with heavy winds ripped through the Paul's California neighborhood, toppling a large oak tree in his front yard. The tree fell on the roof of his garage and caused structural damage to a significant portion of the garage. Paul had California Construction (a construction company) repair the structural damage caused by storm. The costs of repair totaled $15,000. Paul filed a homeowner's insurance claim with Acme Insurance for $15,000 (he has a $0 deductible policy). Acme Insurance approved Paul's claim and agreed to reimburse him for the entire $15,000 amount.

Acme Insurance agreed to reimburse Paul using a fund disbursement transaction. At a first step (S1), Paul provides Acme Insurance's merchant system 614 with his debit card, such that the merchant system 614 has the required account identifier(s) associated with Paul's consumer account associated with his debit card. At a second step (S2), the merchant system 614 communicates a fund disbursement request to the DPS 616, the fund disbursement request including the account identifier(s) for Paul's consumer account and/or the disbursement amount ($15,000) for the fund disbursement transaction. The fund disbursement request may also include account identifiers associated with Acme Insurance's merchant account. From the fund disbursement request, the DPS 616 may determine the merchant account from which the $15,000 is to be transferred and the consumer account to which the $15,000 is to be transferred.

At a third step (S3), the First Gateway DPS 616 generates the first authorization request (as previously described) to cause the First Acquirer acquirer system 120 corresponding to the merchant account to determine whether the merchant account has sufficient funds. In this example, the DPS communicates the first authorization request to First Transaction Service Provider's TPS 618. At a fourth step (S4), the TPS 618 communicates the received first authorization response to the acquirer system 622. At a fifth step (S5), the acquirer system 622 determines whether the merchant account has sufficient funds (at least $15,000) to cover the disbursement amount. Other acquirer-established rules may be considered by various systems (e.g., the DPS 616, the TPS 618, the acquirer system 622, and/or the issuer system 620) to determine whether the disbursement request is also compliant therewith. At a sixth step (S6), the acquirer system 622 communicates a first authorization response to the TPS 618, and at a seventh step (S7), the TPS 618 communicates the first authorization response to the DPS 616.

With continued reference to FIG. 6, at an eighth step (S8), in response to determining that the first authorization response includes an approval authorizing disbursal of the disbursement amount (it was determined that the merchant account includes at least $15,000), the DPS 616 generates and communicates the second authorization request to the TPS 618. This second authorization request is as previously described and is configured to cause the issuer system 620 to initiate a push payment of the disbursement amount to Paul's consumer account. At a ninth step (S9), the TPS 618 communicates the second authorization request to the issuer system 620 of First Bank.

At a tenth step (S10), the issuer system 620 may effect the push payment of the disbursement amount to the consumer account, such that the $15,000 is available to Paul. The disbursement amount may be made available to Paul within 1 hour or the merchant system 614 communicating the fund disbursement request to the DPS 616. At an eleventh step (S11), the TPS 618 and the acquirer system 622 communicate to transfer the disbursement amount from an acquirer system 622 to the TPS 618 (since the TPS 618 transfers the disbursement amount to the issuer system 620). In this example, the TPS 618 pulls the disbursement amount from the acquirer account of the acquirer system 622. At a twelfth step (S12), the merchant system 612 and the acquirer system 622 communicate to transfer the disbursement amount from the merchant account of the merchant system 614 to the acquirer account of the acquirer system 622. In this example, the acquirer system 622 (or the TPS 618 on behalf of the acquirer system 622) pulls the disbursement amount from the merchant system 614. In this way, the disbursement amount of $15,000 is transferred from Acme Insurance's merchant account to Paul's consumer account within 1 hour of the fund disbursement request so that the funds are quickly available to Paul, while ensuring that Acme Insurance's merchant account contains sufficient funds to cover the amount.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A computer-implemented method for processing a fund disbursement transaction, comprising:
receiving, with at least one processor of a disbursement provider system, a fund disbursement request identifying a disbursement amount to be disbursed to a consumer account from a merchant account;
determining, with the at least one processor and based partially on the fund disbursement request, the merchant account from which the disbursement amount is to be transferred and the consumer account to which the disbursement amount is to be transferred;
generating, with the at least one processor, a first authorization request based on the disbursement amount and the merchant account;
communicating, with the at least one processor, the first authorization request to the acquirer system;
receiving, with the at least one processor, a first authorization response from the acquirer system including a determination as to whether the merchant account includes the disbursement amount; and
in response to determining, with the at least one processor, that the first authorization response comprises an approval authorizing disbursal of the disbursement amount, generating a second authorization request configured to cause an issuer system corresponding to the consumer account to initiate a push payment of the disbursement amount to the consumer account.

2. The computer-implemented method of claim 1, wherein the second authorization request comprises a type identifier identifying an interchange fee associated with the fund disbursement transaction.

3. The computer-implemented method of claim 1, further comprising: in response to determining that the merchant account includes the disbursement amount, placing a hold on the merchant account for the disbursement amount.

4. The computer-implemented method of claim 1, wherein the second authorization request is communicated within 1 hour of receiving the fund disbursement request.

5. The computer-implemented method of claim 1, wherein the disbursement provider system comprises a payment gateway.

6. The computer-implemented method of claim 1, wherein the fund disbursement request is initiated using a debit card corresponding to the consumer account.

7. The computer-implemented method of claim 1, wherein the acquirer system corresponding to the merchant account is operated by an issuer that issued a debit card corresponding to the merchant account.

8. The computer-implemented method of claim 1, wherein the merchant account corresponds to an enterprise merchant.

9. A disbursement provider system for processing a fund disbursement transaction, comprising at least one server computer including at least one processor, the at least one server computer programmed and/or configured to:
receive a fund disbursement request identifying a disbursement amount to be disbursed to a consumer account from a merchant account;
determine, based partially on the fund disbursement request, the merchant account from which the disbursement amount is to be transferred and the consumer account to which the disbursement amount is to be transferred;
generate a first authorization request based on the disbursement amount and the merchant account;
communicate the first authorization request to the acquirer system;
receive a first authorization response from the acquirer system including a determination as to whether the merchant account includes the disbursement amount; and
in response to determining that the first authorization response comprises an approval authorizing disbursal of the disbursement amount, generate a second authorization request configured to cause an issuer system corresponding to the consumer account to initiate a push payment of the disbursement amount to the consumer account.

10. The system of claim 9, wherein the second authorization request comprises a type identifier identifying an interchange fee associated with the fund disbursement transaction.

11. The system of claim 9, wherein the at least one server computer is further programmed and/or configured to:
in response to determining that the merchant account includes the disbursement amount, place a hold on the merchant account for the disbursement amount.

12. The system of claim 9, wherein the second authorization request is communicated within 1 hour of receiving the fund disbursement request.

13. The system of claim 9, wherein the disbursement provider system comprises a payment gateway.

14. The system of claim 9, wherein the fund disbursement request is initiated using a debit card corresponding to the consumer account.

15. The system of claim 9, wherein the acquirer system corresponding to the merchant account is operated by an issuer that issued a debit card corresponding to the merchant account.

16. The system of claim 9, wherein the merchant account corresponds to an enterprise merchant.

17. A computer program product for processing a fund disbursement transaction, comprising at least one non-transitory computer-readable medium including program instructions that, when executed by at least one processor, cause the at least one processor to:
receive on a disbursement provider system a fund disbursement request identifying a disbursement amount to be disbursed to a consumer account from a merchant account;
determine, based partially on the fund disbursement request, the merchant account from which the disbursement amount is to be transferred and the consumer account to which the disbursement amount is to be transferred;
generate a first authorization request based on the disbursement amount and the merchant account;
communicate the first authorization request to the acquirer system;
receive a first authorization response from the acquirer system including a determination as to whether the merchant account includes the disbursement amount; and
in response to determining that the first authorization response comprises an approval authorizing disbursal of the disbursement amount, generate a second authorization request configured to cause an issuer system corresponding to the consumer account to initiate a push payment of the disbursement amount to the consumer account.

18. The computer program product of claim 17, wherein the second authorization request comprises a type identifier identifying an interchange fee associated with the fund disbursement transaction.

19. The computer program product of claim 17, wherein the program instructions further cause the at least one processor to:
in response to determining that the merchant account includes the disbursement amount, place a hold on the merchant account for the disbursement amount.

20. The computer program product of claim 17, wherein the second authorization request is communicated within 1 hour of receiving the fund disbursement request.

21. The computer program product of claim 17, wherein the disbursement provider system comprises a payment gateway.

22. The computer program product of claim 17, wherein the fund disbursement request is initiated using a debit card corresponding to the consumer account.

23. The computer program product of claim 17, wherein the acquirer system corresponding to the merchant account is operated by an issuer that issued a debit card corresponding to the merchant account.

24. The computer program product of claim 17, wherein the merchant account corresponds to an enterprise merchant.
